(19) United States
(12) Patent Application Publication
(10) Pub. No.: US 2010/0232961 A1
(43) Pub. Date: Sep. 16, 2010

(54) FIBRE OPTIC SENSORS

(75) Inventors: Mark Volanthen, Southampton (GB); Glynn David Lioyd, Southampton (GB)

Correspondence Address: RENNER OTTO BOISSELLE & SKLAR, LLP, 1621 EUCLID AVENUE, NINETEENTH FLOOR, CLEVELAND, OH, 44115, US

(73) Assignee: Insensys Limited

(21) Appl. No.: 12/377,923

(22) PCT Filed: Aug. 20, 2007
(86) PCT No.: PCT/GB07/03177

§ 371 Date: Apr. 20, 2010

(30) Foreign Application Priority Data
Aug. 18, 2006 (GB) 0616507.0

(51) Int. Cl. F03D 7/02; G01B 11/16; G02B 6/00

(52) U.S. Cl. 416/61; 356/32; 385/12

(57) ABSTRACT

A wind turbine blade (1) incorporating an optical fibre (4) configured for structural monitoring of the turbine blade. The optical fibre comprises at least one strain sensor (5). One end of the optical fibre (4) is an output point, which is connected to a data processing device (3) configured to process signals from the strain sensor (5). The other end of the optical fibre is an alternative output point, which is also connectable to the data processing device, such that in the event of a breakage in the optical fibre, signals from the strain sensor are available from at least one of the output points.

### FIELD OF THE INVENTION

This invention relates to the structural monitoring of structures, such as wind turbine blades, and, in particular, to the structural monitoring of structures using fibre optic Bragg grating sensors.

### BACKGROUND TO THE INVENTION

Blades for wind turbines are typically constructed of glass-reinforced plastics (GRP) on a sub-structure, which may be formed of wood, glass fibre, carbon fibre, foam or other materials. Graphite fibre in epoxy resin is also used. The plastics resin can be injected into a mould containing the sub-structure to form the outer surface of the blade. The blade may also be built up as a series of layers of fibre material and resin. In some cases, the fibre material is pre-impregnated with resin.

A typical wind turbine blade may have a length of between 20 and 60 metres or more. As the interior of the blade is generally hollow, a “floor” is provided within the blade proximate the hub-engaging end of the blade. The blade floor is a bulkhead about 0.5 metres to 2.5 metres into the blade that prevents service personnel falling into a blade while working in the hub.

It is known, for example from U.S. Pat. No. 4,297,076, to provides the blades of a wind turbine with strain gauges and to adjust the pitch of portions of the blades in response to the bending moment on the blades measured by the strain gauges. Optical fibre strain sensors are known and WO 2004/056017 discloses a method of interrogating multiple fibre Bragg grating strain sensors forming an array along a single fibre. In the system of WO 2004/056017, Bragg gratings are defined in the optical fibre at spaced locations along the optical fibre. When the optical fibre is put under strain, the relative spacing of the planes of each Bragg grating changes and thus the resonant optical wavelength of the grating changes. By determining the resonant wavelength of each grating, a strain measurement can be derived for the location of each grating along the fibre. Optical strain sensors operating on the principle of back scattering which do not require discrete gratings along the fibre are also known.

During the manufacture of a turbine blade, optical fibre strain sensors my be embedded within the structure of the turbine blade in order that the mechanical loads on the turbine blade can be monitored when the blade is in use as part of a wind turbine.

Optical fibres in a turbine may break during the course of service. The break may be in the blade or the interconnecting cables. Because the optical fibre of the strain sensor is often an integral part of the turbine blade structure, any breakage of the optical fibre within the blade cannot easily be repaired and will require a technician to enter the blade structure and replace the fibre. A break in the optical fibre can cause the structural monitoring system to fail completely, or at least in respect of the particular blade.

It would be desirable to provide a turbine blade that can be monitored structurally and is capable of tolerating a breakage in the optical fibre for strain sensing. This invention, at least in the preferred embodiments, seeks to provide a scheme for coping with a single failure in the optical circuit of a structural monitoring system and restoring full operation.

### SUMMARY OF THE INVENTION

Viewed from a first aspect, the invention provides an optical fibre system configured for structural monitoring of a structure, such as a turbine blade, the optical fibre comprising at least one optical fibre Bragg grating sensor, wherein both ends of the optical fibre are connected to a common output point connectable, in use of the structure, to a data processing device configured to process signals from the fibre Bragg grating sensor, and the length of the optical fibre between the sensor and one end of the optical fibre is different to the length of the optical fibre between the sensor and the other end of the optical fibre, such that signals travelling in one direction along the optical fibre can be differentiated from signals travelling in the other direction along the optical fibre by the time of arrival of the signals at the output point.

Typically, the Bragg grating sensor is arranged as a strain sensor, in use. In general, the optical fibre incorporates multiple fibre Bragg grating sensors in an array along the optical fibre. The two ends of the optical fibre may be located within the structure and may be connected to a further optical fibre which provides a connection to the data processing device, in use. A delay device, such as a delay coil, may be provided in the signal path formed by the optical fibre.

Viewed from a further aspect, this invention provides a wind turbine blade incorporating an optical fibre configured for structural monitoring of the turbine blade, the optical fibre comprising at least one strain sensor, wherein one end of the optical fibre is an output point, which is connectable, in use of the turbine blade, to a data processing device configured to process signals from the strain sensor, and the other end of the optical fibre is an alternative output point, which is also connectable, in use of the turbine blade, to the data processing device configured to process signals from the strain sensor, such that in the event of a breakage in the optical fibre, signals from the strain sensor are available from at least one of the output points.

Thus, according to this aspect of the invention, either output point can be used to interrogate the strain sensor(s), even if there is a break in the optical fibre.

Typically, the strain sensors are optical fibre strain sensors, for example fibre Bragg gratings. The fibre Bragg gratings may be configured to operate as temperature sensors in addition or as an alternative to strain sensors. Alternatively, the entire optical fibre may be a strain sensor, for example operating on the principle of back scattering. The turbine blade typically incorporates multiple strain sensors in an array along the optical fibre. It is not necessary for the optical fibre to be a single continuous fibre. The optical fibre may be formed by discrete fibre joined together to form a continuous signal path between the two ends.

In general, the output points provides not only a signal path for signals from the strain sensors, but also a signal path for signals from the data processing device to the strain sensors. In the case of optical strain sensors, such signals are typically pulses of light that are reflected by the gratings of the sensors. In this case, signals originating from the output point travel along the signal path in one direction on their outward journey and return in the opposite direction once reflected. The direction of travel along the optical fibre from the output point to the strain sensor is opposite to the direction from the alternative output point to the strain sensor.

The output point and the alternative output point may be provided by the free ends of the optical fibre exiting the structure of the turbine blade. In this case, the optical fibre may form a loop within the turbine blade, with the two ends exiting in generally the same direction.

Alternatively, the two ends may be located within the structure of the turbine blade with a further connection or connections, for example optical connection(s), to the data processing device. In particular, the two ends of the optical fibre both may be connected to a further optical fibre which provides a connection to the data processing device, in use. Thus, the further optical fibre may be connected to the ends of the optical fibre by a splitter to form a branching point. Between one of the output points and the strain sensors, a delay device, such as a delay coil, may be provided in the signal path formed by the optical fibre. The length of the delay may be selected such that the source (output point) of signals arriving at the data processing device can be determined by the time of arrival of the signals.

The invention also extends to a sub-structure incorporating an optical fibre mounted to a substrate and adapted to form a wind turbine blade according to the invention.

### BRIEF DESCRIPTION OF THE DRAWINGS

An embodiment of the invention will now be described by way of example only and with reference to the accompanying drawings, in which:

FIG. 1 is a schematic view of a wind turbine incorporating optical fibre strain sensors for structural monitoring according to an embodiment of the invention;

FIG. 2 is a schematic view of a wind turbine incorporating optical fibre strain sensors for structural monitoring according to a further embodiment of the invention;

FIG. 3 is a schematic view of a wind turbine incorporating optical fibre strain sensors for structural monitoring according to a yet further embodiment of the invention;

FIG. 4 is a schematic view of a the detail of the embodiment of FIG. 3; and

FIGS. 5 and 6 are schematic views of an alternative application of the embodiment of FIG. 2.

### DETAILED DESCRIPTION OF AN EMBODIMENT

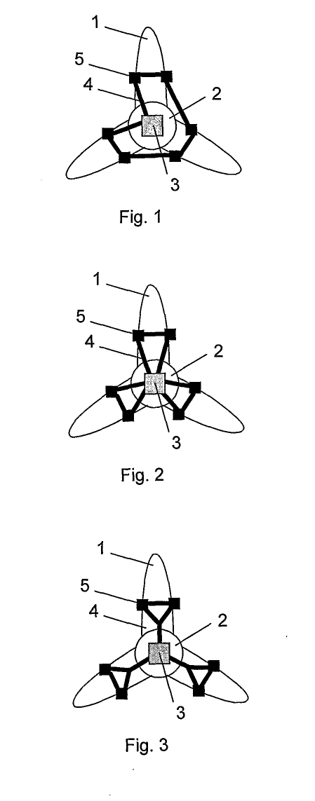

FIG. 1 is a schematic view of a wind turbine incorporating optical fibre strain sensors for structural monitoring. The turbine comprises three blades 1 connected to a hub 2. Located within the hub 2 is a data processing device (instrument) 3 which sends and receives pulses of light to and from optical fibre strain sensors 5 mounted to each of the blades 1. The optical fibre strain sensors 5 are connected to the instrument 3 by optical fibres 4. When the blades 1 flex in the wind, the resonant wavelength of the Bragg gratings forming the strain sensors 5 changes and from this change in resonant wavelength, the strain on the blade 1 can be determined.

A typical optical fibre sensor system uses wavelength division multiplexing (WDM) to accommodate the signals from each strain sensor 5 along the optical fibre 4. Each sensor in the same array is identified by its wavelength λ₁, λ₂, λ_{3,} etc. and must therefore have a different wavelength at all times from other sensors 5 in the same array.

In the embodiments of FIGS. 1 to 3, every optical circuit is a loop that can be measured from both ends of the optical fibres 4. A single break anywhere in the loop does not result in the loss of any sensor data.

FIG. 1 shows a daisy-chained system with the spare end of the optical fibre 4 terminated back at the instrument 3. This system is single break tolerant since the instrument 3 can extract measurement date from the strain sensor up to the break from either end of the optical fibre.

FIG. 2 shows a further embodiment of the invention where each blade 1 includes its own loop of optical fibre 4 terminated at the instrument 3. Both ends of the optical fibre for each blade 1 are brought back to the instrument 3 to complete the loop. This arrangement requires the instrument 3 to be able to process six data channels.

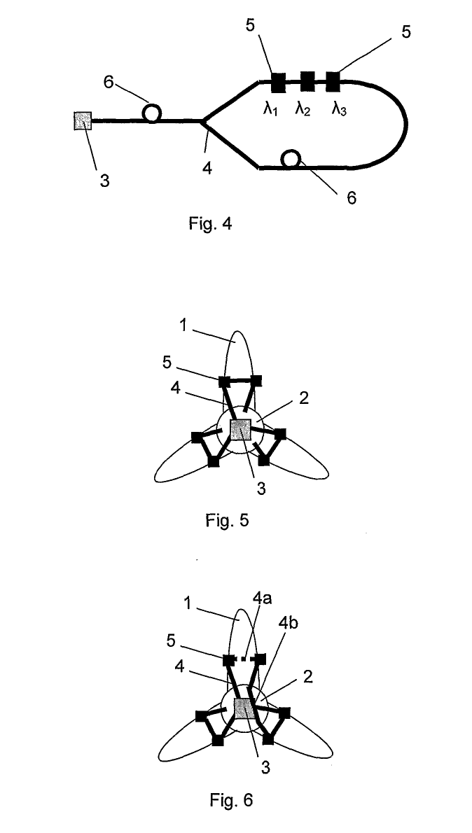

FIG. 3 shows a yet further embodiment of the invention that is tolerant to a single break in the loop of optical fibre in the blade 1. In this case the loop of optical fibre is formed by splitting the signal path along a single cable from the instrument within the blade. Thus, each blade 1 is provided with a loop with a single cable between the loop and the instrument 3. FIG. 4 shows the detail of this arrangement. The strain sensors 5, each having a different, characteristic wavelength λ₁, λ₂, λ₃ are provided in the loop. A delay coil 6 is also provided in the loop. The delay coil 6 ensures that the signals that reach the instrument 3 are spaced in time depending on their path to and from the strain sensors 5. Thus, signals which pass around the loop clockwise in FIG. 4 and are reflected by one of the strain sensors 5, never pass through the delay coil 6 in the loop. Signals which pass around the loop clockwise in FIG. 4 and pass through all the strain sensors 5, pass once through the delay coil 6 in the loop on their way back to the instrument. Signals which pass around the loop anti-clockwise in FIG. 4 and pass though all the strain sensors 5, pass once through the delay coil 6 in the loop on their way to the strain sensors. Signals which pass around the loop anti-clockwise in FIG. 4 and are reflected by one of the strain sensors 5, pass twice through the delay coil 6 in the loop. In this way, the length of delay coil 6 can be selected so that each set of reflected signals can be differentiated from each other and from the transmitted signals by their time of flight relative to the original pulse of light from the instrument 3.

The embodiment of FIG. 5 requires intervention to correct for a breakage in the loop. In this embodiment, both ends of each blade fibre are brought to the connection box for the instrument 3 replaceable connector cables are used between the instrument 3 and the fibres 4 in the blades. When a optical fibre is broken as indicated by the dashed fibre 4a in FIG. 6, an additional cable 4b can be used to reconnect the isolated sensors 5. A break in the cable between the instrument 3 and the connector box is addressed by replacing that cable.

Although the invention has been described in the context of wind turbine blades, it is possible that the apparatus of the invention could be used in other fields. Such fields are not intended to be excluded from the scope of this disclosure. In addition, it is possible for the principles of the invention to be applied to electrical strain sensors connected with an electrical transmission line, rather than an optical fibre. The optical fibre configuration is, however, strongly preferred.

In summary, a wind turbine blade 1 incorporating an optical fibre 4 configured for structural monitoring of the turbine blade. The optical fibre comprises at least one strain sensor 5. One end of the optical fibre 4 is an output point, which is connected to a data processing device 3 configured to process signals from the strain sensor 5. The other end of the optical fibre is an alternative output point, which is also connectable to the data processing device, such that in the event of a breakage in the optical fibre, signals from the strain sensor are available from at least one of the output points.

1. An optical fibre system configured for structural monitoring of a structure, the optical fibre comprising at least one optical fibre Bragg grating sensor, wherein both ends of the optical fibre are connected to a common output point connectable, in use of the structure, to a data processing device configured to process signals from the fibre Bragg grating sensor, and the length of the optical fibre between the sensor and one end of the optical fibre is different to the length of the optical fibre between the sensor and the other end of the optical fibre, such that signals traveling in one direction along the optical fibre can be differentiated from signals traveling in the other direction along the optical fibre by the time of arrival of the signals at the output point.

2. A system as claimed in claim 1, wherein the Bragg grating sensor is arranged as a strain sensor, in use.

3. A system as claimed in claim 1, wherein the optical fibre incorporates multiple fibre Bragg grating sensors in an array along the optical fibre.

4. A system as claimed in claim 1, wherein the two ends of the optical fibre are located within the structure and are connected to a further optical fibre which provides a connection to the data processing device, in use.

5. A system as claimed in claim 1, wherein a delay device, such as a delay coil, is provided in the signal path formed by the optical fibre.

6. A system as claimed in claim 1, wherein the structure is a wind turbine blade.

7. A wind turbine blade incorporating an optical fibre configured for structural, monitoring of the turbine blade, the optical fibre comprising at least one strain sensor, wherein one end of the optical fibre is an output point, which is connectable, in use of the turbine blade, to a data processing device configured to process signals from the strain sensor, and the other end of the optical fibre is an alternative output point, which is also connectable, in use of the turbine blade, to the data processing device configured to process signals from the strain sensor, such that in the event of a breakage in the optical fibre, signals from the strain sensor are available from at least one of the output points.

8. A turbine blade as claimed in claim 7, wherein the strain sensors are optical fibre strain sensors, such as fibre Bragg gratings.

9. A turbine blade as claimed in claim 7, wherein the turbine blade incorporates multiple strain sensors in an array along the optical fibre.

10. A turbine blade as claimed in claim 7, wherein the output point and the alternative output point are provided by the free ends of the optical fibre exiting the structure of the turbine blade.

11. A turbine blade as claimed in claim 7, wherein the two ends of the optical fibre are located within the structure of the turbine blade and are connected to a further optical fibre which provides a connection to the data processing device, in use.

12. A turbine blade as claimed in claim 11, wherein a delay device, such as a delay coil, is provided in the signal path formed by the optical fibre.

13. A sub-structure incorporating an optical fibre mounted to a substrate and adapted to form a wind turbine blade according to claim 7
